(19) United States
(12) Patent Application Publication
(10) Pub. No.: US 2012/0182404 A1
(43) Pub. Date: Jul. 19, 2012

(54) Three Dimensional Display

(75) Inventors: Chao-Yong HSU, Changhua City (TW); Tao-Ching Yu, Longtan Township (TW); Jhen-Shen Liao, Bade City (TW); Yung-Yu Hsieh, Dongshi Township (TW)

(73) Assignee: CHUNGHWA PICTURE TUBES, LTD., Bade City (TW)

(21) Appl. No.: 13/093,818

(22) Filed: Apr. 25, 2011

(30) Foreign Application Priority Data
Jan. 13, 2011 (TW) 100101317

(51) Int. Cl. H04N 13/04

(52) U.S. Cl. 348/54; 348/E13.075

(57) ABSTRACT

A three dimensional display is disclosed, and the pixel unit matrix thereof includes a central area, an upper area and a lower area, a left and a right area and matrix corner areas, which are composed of sub-pixels with different colors or partially identical colors. By aforementioned arrangement, the present invention can provide a pixel array different from conventional RGB array, so that the 3D stereo image can still be attained effectively while the stereo display is rotated under various directions or angles.

### CROSS REFERENCE TO RELATED APPLICATION

This present application claims priority to TAIWAN Patent Application Serial Number 100101317, filed on Jan. 13, 2011, which are herein incorporated by reference.

### TECHNICAL FIELD

The present invention generally relates to a stereo display device, in particular, to a stereo display device capable of being viewed in various viewing angles.

### DESCRIPTION OF THE RELATED ART

In advance of the industrial revolution, it had been discovered that human would not be obsessed by seeing two images, even though he or she has two eyes and the images received in corresponding retina are not totally identical. After strict experiments in animals and human bodies, it's further proved that there are some cells specializing in stereo vision on the retina, and the brain can mix those images from different viewing angles to generate effect of the depth perception, and therefore, human can feel space impression though the eyes.

In pace with the progress and the growth of the technology, the display technology exhibits an unprecedented development in recent years. That is, the 3D (three-dimensional) stereo image can be displayed on the flat display due to the effect of the binocular parallax. The binocular parallax means that the images seen by each eye are slightly different because the locations and the viewing angles of each eye are different, and those two images can be merged to a stereo image by the brain. In terms of the appearance, the stereo display technology can be classified as a stereoscopic one in which the particularly designed eyeglasses is required and an auto-stereoscopic one in which the stereo images can be viewed directly without glasses. The stereoscopic display technology can be generally classified as color filter glasses, polarizing glasses, and shutter glasses, etc, and those glasses mainly utilize a display to transmit left-eye images and right-eye images with particular messages, and further employ the head-mounted glasses for respectively making the left eye seeing left-eye images and the right eye seeing right-eye images, so as to generate stereo vision.

However, the stereoscopic display technology is not popular in ordinary life all the time since it may cause much inconvenience and discomfort for the user, and hence, the auto-stereoscopic display gradually becomes the main trend in the stereo display technology. In the conventional auto-stereoscopic display, generally speaking, the frame may be cut in regular intervals to be the left-eye image display zone and the right-eye image display zone, and the barrier or the striped lenticular screen can be further introduced to project aforementioned images respectively into the left eye and the right eye, so as to achieve stereo effect. Simply speaking, two images of different viewing angles can be inputted into human eyes to generate a 3D image through the barrier or the striped lenticular screen. Thus, regarding the data in the panel, it only needs to put image data with two different viewing angles in the same panel, and further employs the barrier to shade the image of different viewing angle for making the left eye and the right eye receive the corresponding image respectively, so that the 3D image can be formed in the brain. Specifically, referred to FIG. 1, FIG. 2a and FIG. 2b, FIG. 1 depicts a pixel array 101 with two different viewing angles data, and FIG. 2a and FIG. 2b individually show the images received by the left eye and the right eye when the barrier 201 is mounted on the pixel array 101. In FIG. 1, the pixel array 101 comprises a plurality of red sub-pixels 102, green sub-pixels 103 and blue sub-pixels 104, which are horizontally arranged in sequence, thereby facilitating to mix different colors for generating color image. In this case, part of sub-pixels shows data of the left-eye (or right-eye) viewing angle, such as the sub-pixels tagged “1” in this figure, and another part of sub-pixels shows data of the right-eye (or left-eye) viewing angle, such as the sub-pixels tagged “2” in this figure. And referred to FIG. 2a and FIG. 2b, the barrier 201 is a parallel-latticed structure with an identical interval and an oblique angle, so that the light emitted from the sub-pixels tagged “1” can be shaded to not be emitted into the right eye (or left eye) of the user, and the light emitted from the sub-pixels tagged “2” can be shaded to not be emitted into the left eye (or right eye) of the user. The oblique angle is principally determined according to the staggered arrangement of the two kinds of pixels in FIG. 1. In other words, when the light emitted from the pixel array 101 passes through the barrier, the left eye of the user can merely see those sub-pixels tagged “1”, as shown in FIG. 2a, and the right can merely see those sub-pixels tagged “2”, as shown in FIG. 2b. By aforementioned means, each eye can respectively obtain image data with different viewing angles, and the image data can be re-merged by the visual system in the brain, thereby forming a 3D image with depth perception.

However, in the RGB pixel array of the barrier-type stereo display, no matter the left eye or the right eye, the image merged by each RGB sub-pixel can only be seen in a single direction (or angle). Hence, if the display is reversed or rotated to other angles, the image merged by each RGB sub-pixel can not be seen, thereby failing to generate the stereo image. For example, if FIG. 2a or FIG. 2b is rotated 90 degrees along the clockwise direction, the sub-pixels in the first row are all red, namely, only RRR image data can be seen in the first row. On the other hand, if FIG. 2a or FIG. 2b is rotated 90 degrees along the counterclockwise direction, the sub-pixels in the first row are all blue, namely, only BBB image data can be seen in the first row.

Moreover, in the barrier-type stereo display, it is necessary to mount a barrier on the pixel array, so the light transmittance may be lowered, such that the luminosity may be decreased. Therefore, in order to meet the luminous demand of the stereo display, the luminosity of the backlight module in the panel has to be enhanced, thereby increasing the power of the backlight module and the then raising the cost.

Based on aforementioned description, there are some difficulties and shortcomings still existing in the conventional barrier-type stereo display technology to be overcome.

### SUMMARY

To overcome aforementioned shortcomings and difficulties, the present invention provides a stereo display, and more specifically, the present invention provides a barrier-type stereo display capable of being watched in various directions or angles.

One purpose of the present invention is to provide an extraordinary pixel array by the particular arrangement of red, green, blue, and white sub-pixels, so that the 3D stereo image can still be attained effectively while the stereo display is rotated under various directions or angles.

Another purpose of the present invention is to apply the white sub-pixel in the stereo display, whereby ameliorating the issue of reduced luminosity which is derived from the barrier in the typical stereo display.

In order to reach aforementioned purposes, the present invention provides a stereo display, which comprises: a pixel array having a plurality of pixel unit matrices; a backlight module configured at one side by the pixel array, whereby emitting light to the pixel array; and a barrier configured at another side by the pixel array. In this case, each of the plurality of pixel unit matrices comprises: at least one first sub-pixel configured at central area; at least one second sub-pixel configured at upper and lower area adjacent to the central area; at least one third sub-pixel configured at left and right area adjacent to the central area; at least one fourth sub-pixel configured at matrix corner area, which is located at corner of each of the plurality of pixel unit matrices.

By aforementioned particularly designed pixel array, the pixel unit matrix including RGBW sub-pixels can be rendered in the left eye or the right eye when the stereo display is rotated or reversed in various directions, whereby overcoming the shortcoming that the merged image of RGB sub-pixels cannot be seen when the stereo display is reversed because the adjacent sub-pixels have the same color, so as to provide a stereo display capable of exhibiting outstanding imaging effect when being watched in any direction.

Aforementioned description is to illustrate purposes of the present invention, technical characteristics to achieve the purposes, and the advantages derived from the technical characteristics, and so on. And the present invention can be further understood by the following description of the preferred embodiment accompanying with the drawings and the claims.

### BRIEF DESCRIPTION OF THE DRAWINGS

FIG. 1 shows a conventional pixel array.

FIG. 2a shows the image seen by the left eye in the prior art.

FIG. 2b shows the image seen by the right eye in the prior art.

FIG. 3 shows the cross-section diagram of the stereo display.

FIG. 4 shows the preferred embodiment of the pixel array of the present invention.

FIG. 5a shows the diagram that the pixel array observed by the left eye.

FIG. 5b shows the image seen by the left eye of the present invention.

FIG. 6a shows the diagram that the pixel array observed by the right eye.

FIG. 6b shows the image seen by the right eye of the present invention.

FIG. 7a shows the diagram that the pixel array rotated 90 degrees along the clockwise direction observed by the left eye.

FIG. 7b shows the image seen by the left eye when the pixel array is rotated 90 degrees along the clockwise direction.

FIG. 8a shows the diagram that the pixel array rotated 90 degrees along the clockwise direction observed by the right eye.

FIG. 8b shows the image seen by the right eye when the pixel array is rotated 90 degrees along the clockwise direction.

FIG. 9a, 9b to FIG. 20a, 20b show each embodiment of the pixel unit matrix of the present invention.

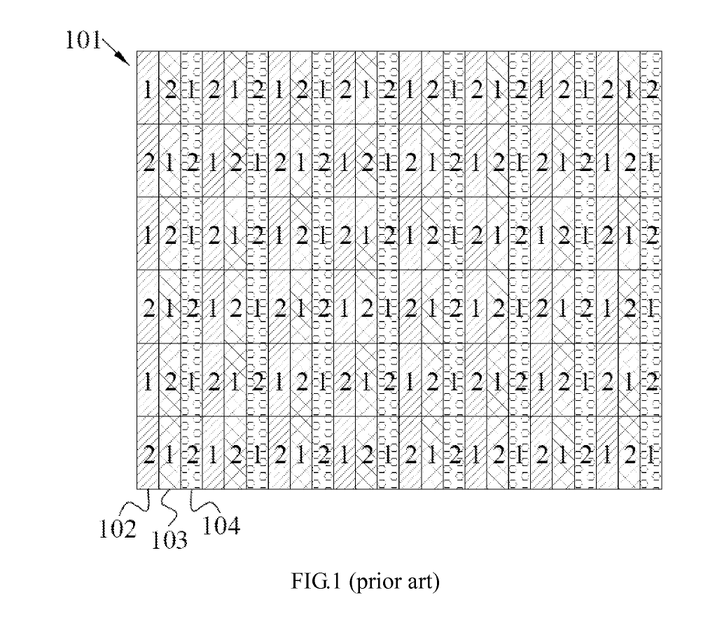

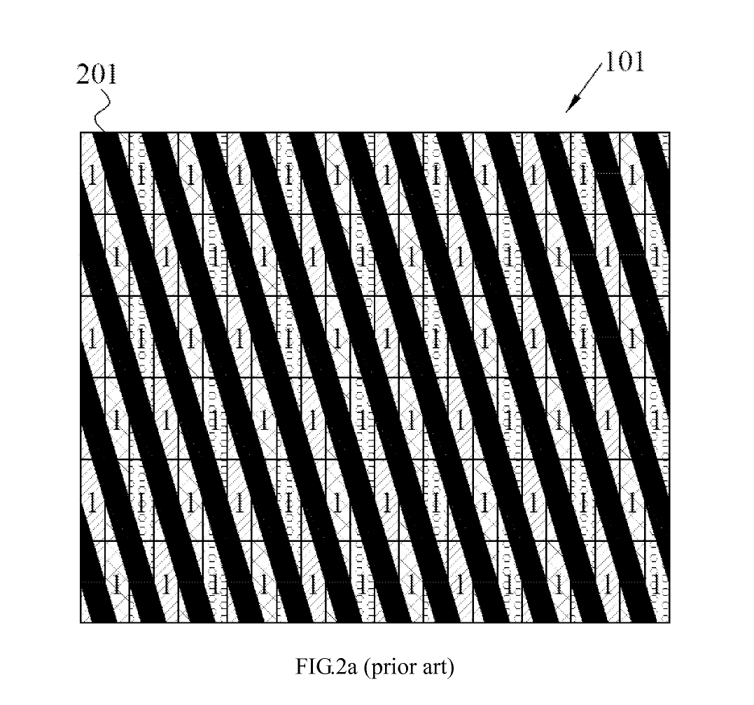

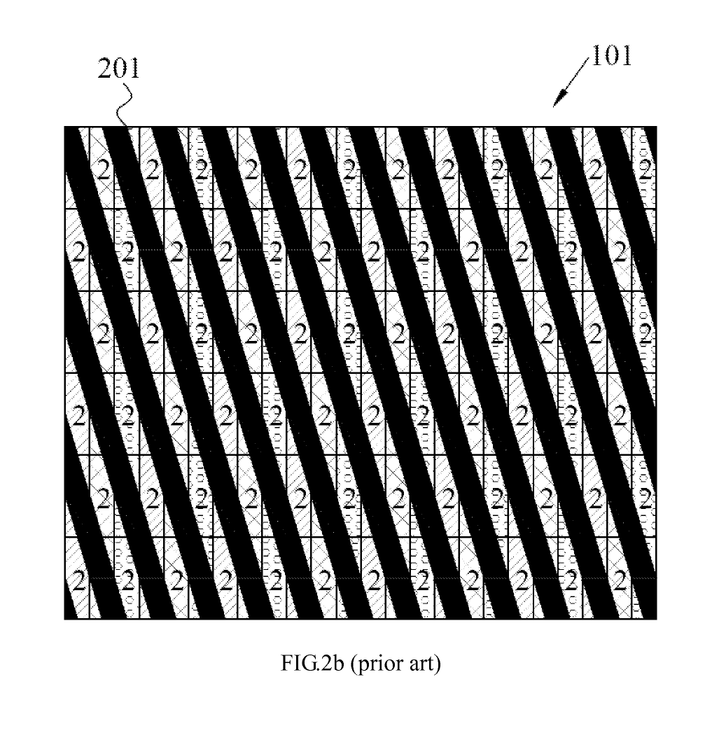

### DETAILED DESCRIPTION

The present invention will be described in preferred embodiments and perspective, which is introduced to illustrate the structures and steps of the present invention, and is just adopted to exemplify the present invention rather than limiting it. Therefore, in addition to the preferred embodiments in the specification, the present invention can also be widely applied to other embodiments.

The present invention discloses an omni-directional stereo display which can be viewed in any direction. The stereo display employs a pixel array configured by RGBW sub-pixels, so that the RGBW sub-pixels is regarded as an unit that can be rendered in the left eye or the right eye when the stereo display is rotated or reversed in various directions. Therefore, no matter how the display is rotated, users can still view the 3D stereo images effectively.

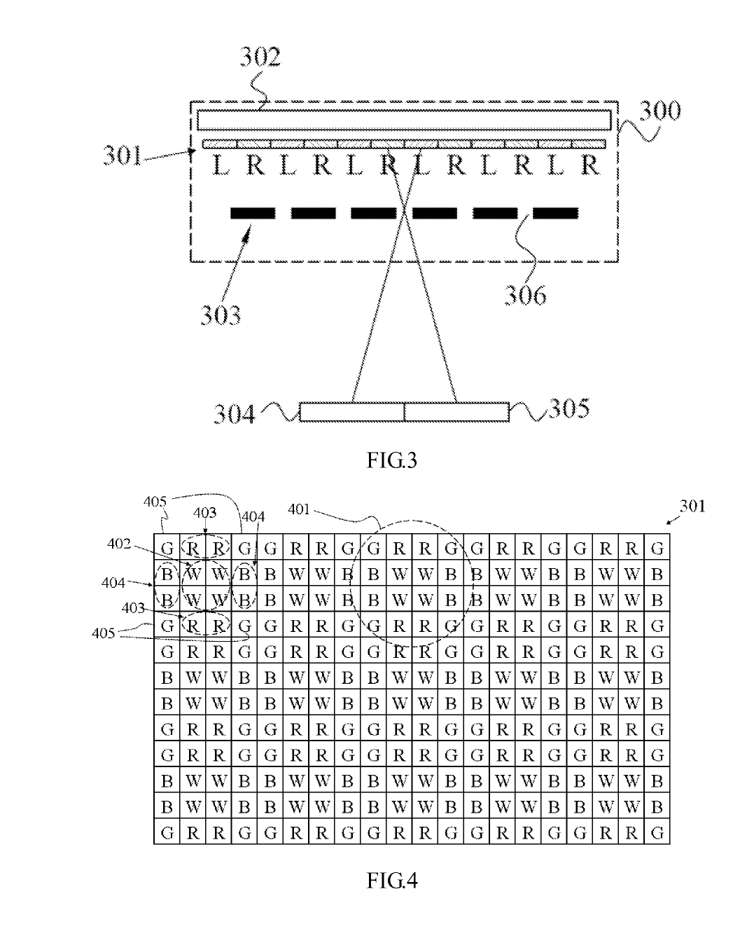

Referred to FIG. 3, which depicts the cross-section diagram of the stereo display of the present invention, the stereo display 300 comprises a pixel array 301, a backlight module 302, and a barrier 303. In this case, the backlight module 302 is configured at one side by the pixel array 301 for providing required light for the pixel array. The barrier 303 is configured at another side of the pixel array 301, and it is a latticed structure, in particular, it's an oblique parallel latticed structure with plural identical intervals 306 which are designed according to the distance between human eyes. When the user watches the image of the stereo display 300 via the left eye 304, the barrier 303 can shade the image data required for the right eye 305, and the required image data for the left eye 304 can be provided through the intervals 306. Similarly, when the user watch the stereo display 300 via the right eye 305, the barrier 303 can shade the image data required for the left eye 304, and the required image data for the right eye 305 can be provided through the intervals 306. In other words, when the user watch the stereo display 300 via the both eyes, the left eye 304 and the right eye 305 can individually receive the required image data through the intervals 306 of the barrier 303, and subsequently, those image data received from the left eye 304 and the right eye 305 individually can be merged in the brain, so as to form the 3D stereo image.

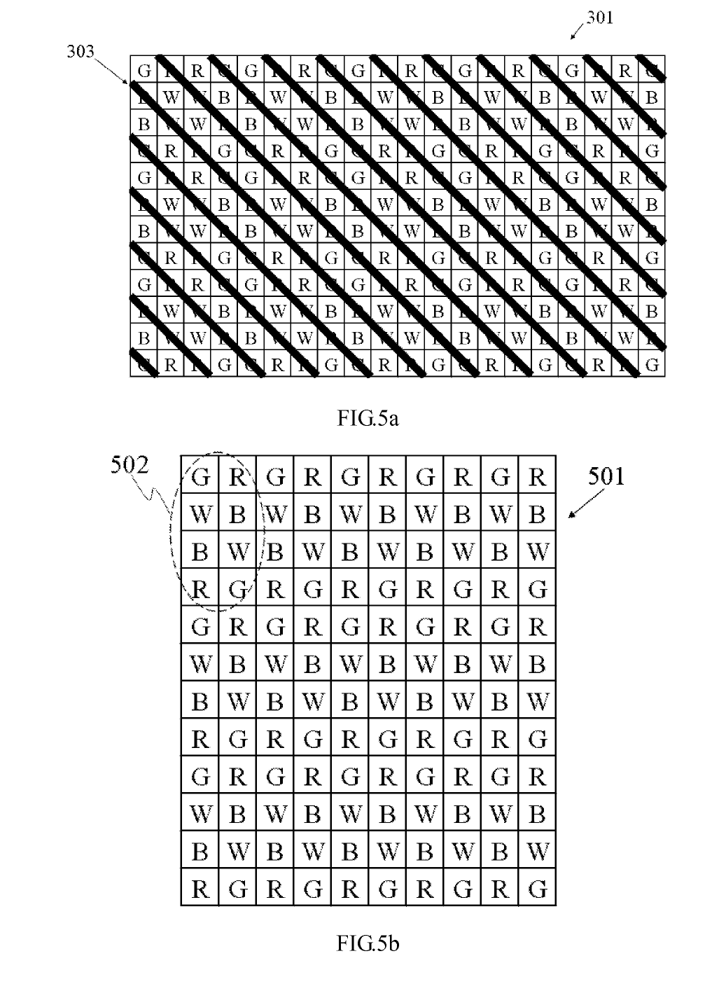

Referred to FIG. 4, which depicts the preferred embodiment of the pixel array 301 disclosed in the present invention, the pixel unit matrix 401 of the pixel array 301 is composed of a plurality of pixels, and each of the pixel unit matrix 401 comprises a plurality of first sub-pixels 402, a plurality of second sub-pixels 403, a plurality of third sub-pixels 404, and a plurality of fourth sub-pixels 405. The present invention introduce a 4×4 matrix for explaining aforementioned pixel unit matrix 401, and hence, the number of aforementioned first sub-pixel 402, second sub-pixel 403, third sub-pixel 404 and fourth sub-pixel 405 are all four. However, any ordinary person having skilled in the related art should understand that aforementioned number of sub-pixels is only illustrated for an example, rather than limiting the scope of the present invention. The quantity can be determined by the user based on demands, such as the 3×3, 5×5, 6×6 . . . or n×n matrix, wherein n is a positive integer.

Under this concept, aforementioned pixel unit matrix 401 includes four first sub-pixels 402 configured at the central area; two pairs of the second sub-pixels 403 configured at the upper and lower area adjacent to the central area, such as the upper side and lower side by the square formed by the central area; two pairs of the third sub-pixels 404 configured at the left and right area adjacent to the central area, such as the left and right side by the square formed by the central area. Four fourth sub-pixels 405 are further configured at the matrix corner area, namely four corners of the matrix, of the pixel unit matrix 401, respectively, thereby constructing a 4×4 pixel unit matrix 401. The first sub-pixel 402 can be white, blue, red, or green colors. The second sub-pixel 403 can also be white, blue, red, or green colors. Similarly, the third sub-pixel 404 and the fourth sub-pixel 405 can also be set by aforementioned colors, but those colors has to be staggered, so as to prevent the neighboring sub-pixel from being the same color to cause the same color is viewed by the left eye or the right eye of the user, and thereby resulting the failure of generating the stereo image. In the embodiment in FIG. 4, the first sub-pixel 402 is set with white color, and the second sub-pixel 403 is set with red color, and the third sub-pixel 404 is blue one, and the fourth sub-pixel 405 is green for illustrating the present invention. Nevertheless, as described above, any arbitrary color can be set in the central area, so are the other areas.

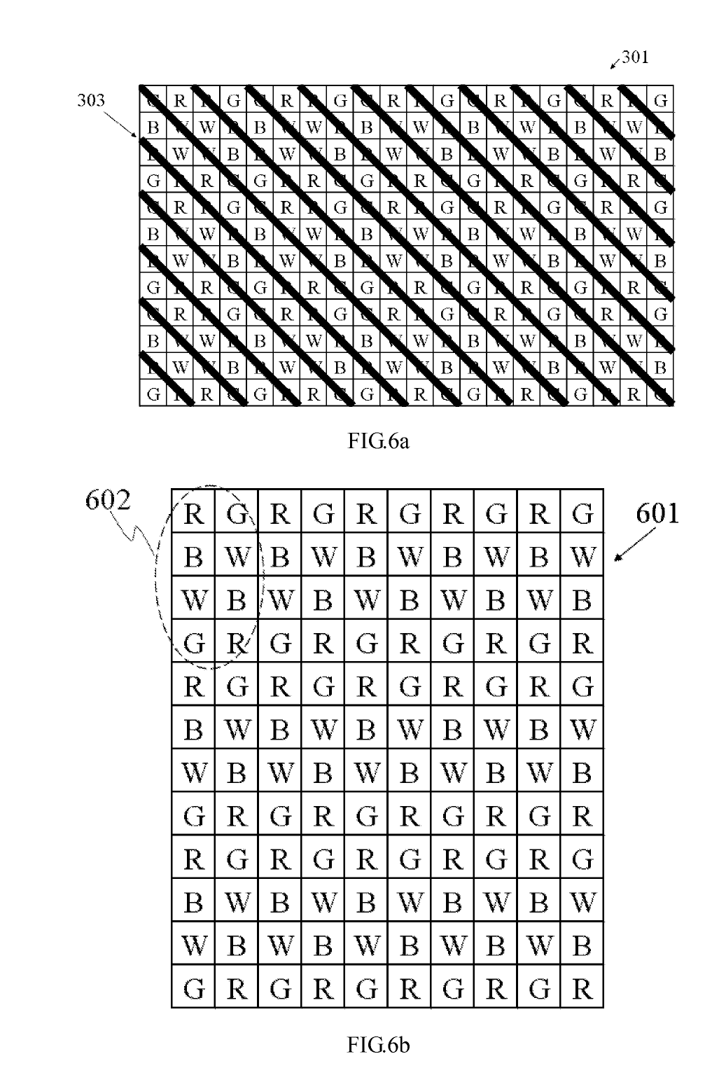

Light transmitted from the pixel array 301 is influenced by the barrier 303, thereby different images are observed by the left eye and the right eye, as shown in FIG. 5a, FIG. 5b, and FIG. 6a, FIG. 6b. FIG. 5a illustrates the diagram of the pixel array 301 and the barrier 303 when they are observed by the left eye 304 of the user, and the FIG. 5b illustrates the pixel array 501 observed by the left eye 304 in the embodiment. As shown in these figures, the barrier 303 with oblique strips can shade part of the sub-pixels in the pixel array 301 obliquely, and those un-shaded sub-pixels can be projected into the left eye 304 of the user, thereby forming the left-eye image consisting by the pixel array 501 in the FIG. 5b. As shown in this figure, the left-eye pixel array 501 is composed of a plurality of left-eye pixel unit matrices 502. Each of the left-eye pixel unit matrices 502 is formed by a column of GWBR (green, white, blue, red) sub-pixels, and a column of RBWG sub-pixels, so as to prevent the identical color in the adjacent sub-pixels from being viewing. Similarly, FIG. 6a illustrates the diagram of the pixel array 301 and the barrier 303 when they are observed by the right eye 305 of the user, and the FIG. 6b illustrates the right-eye image consisting by the pixel array 601 which is observed by the right eye 305 in the embodiment. Like the FIG. 5a, the barrier can shade part of the sub-pixels in the pixel array 301 obliquely, and nevertheless, the shaded sub-pixels by the barrier are different, so that the sub-pixels observed by the right eye 305 are different. Referred to FIG. 6b, the right-eye pixel array 601, which is similar to the left-eye pixel array 501, is also composed of a plurality of right-eye pixel unit matrices 602, and each of them is formed by a column of RBWG sub-pixels and a column of GWBR sub-pixels to avoid the adjacent sub-pixels with same color when they are viewed by the user. Because the same adjacent sub-pixels color issues are resolved for both of the left-eye pixel array 501 and the right-eye pixel array 601, the 3D stereo image can be effectively generated when the stereo display 300 is not rotated.

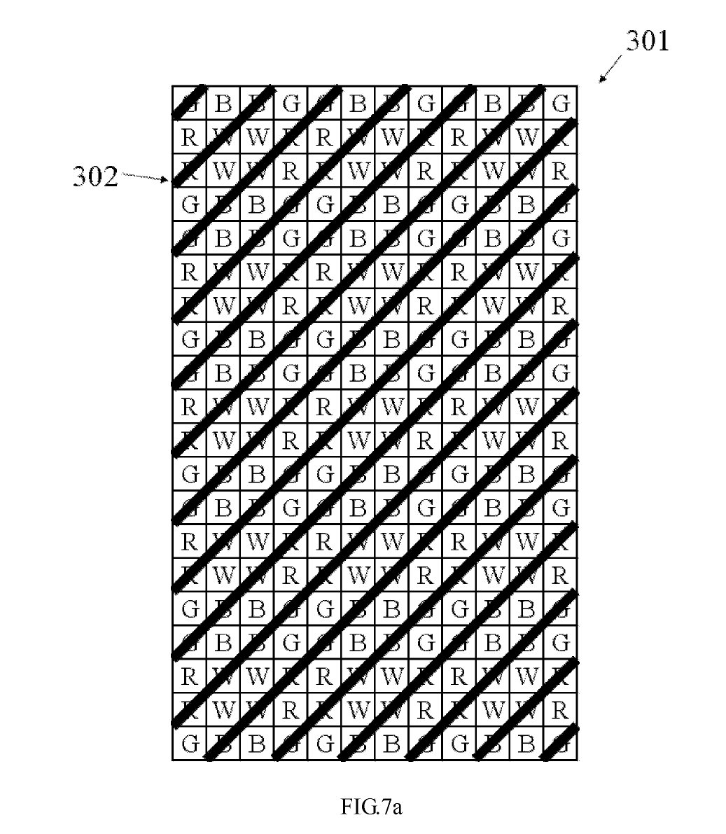

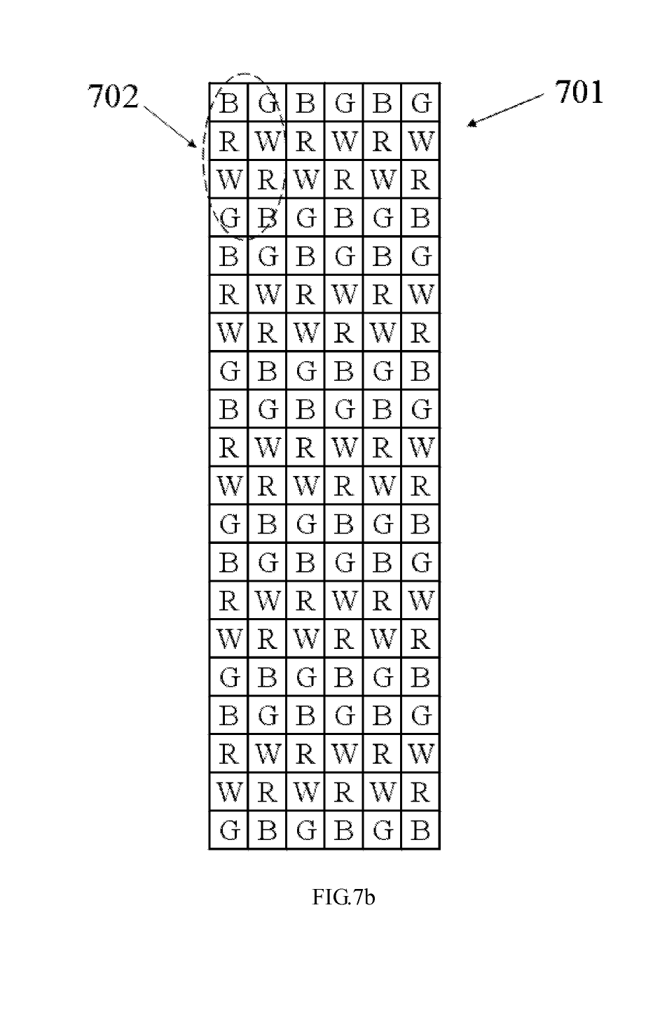

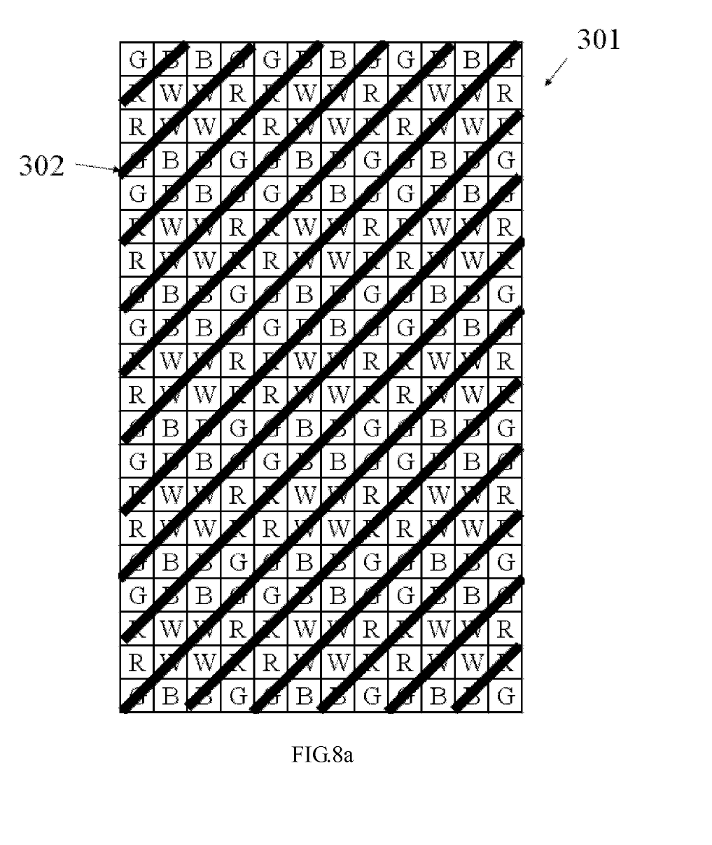

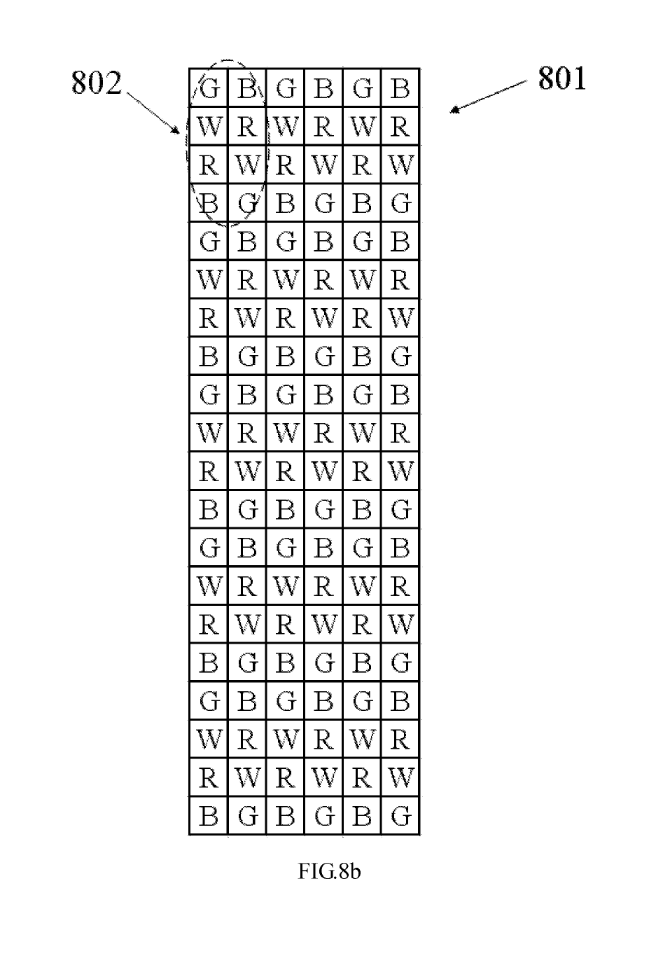

In the following, referred to FIG. 7a, FIG. 7b and FIG. 8a and FIG. 8b, which individually show the pixel array received by the left eye and the right eye after the stereo display 300 is rotated 90 degrees along the clockwise direction. As shown in FIG. 7a, the barrier 303 shades part of sub-pixels in the pixel array 301 obliquely, and the un-shaded sub-pixels can be projected into the left eye 304 of the user, thereby forming the pixel array 701 observed by the left eye, as shown in FIG. 7b. In this case, the left-eye pixel array 701 is composed of a plurality of left-eye pixel unit matrices 702, and each of the left-eye pixel unit matrices 702 is formed by a column of BRWG sub-pixels and a column of GWRB sub-pixels, so as to prevent the issue of identical color in adjacent sub-pixels. On the other hand, FIG. 8a and FIG. 8b illustrate the received pixel array when observed by the right eye 305 of the user. Similar to FIG. 7a, the barrier 303 shades part of sub-pixels in the pixel array 301. However, because the viewing angle of the left eye differs from which of the right eye, the sub-pixels shaded by the barrier are also different, therefore, the sub-pixels being observed by the right eye 305 are also different. Light from aforementioned sub-pixels emitted into the right eye 305 can form the right-eye pixel array 801 in the FIG. 8b. Similar to the left-eye pixel array 701, it is also composed of a plurality of right-eye pixel unit matrices 802, and each of them is formed by a column of GWRB sub-pixels and a column of BRWG sub-pixels, so that the issue of identical color in adjacent sub-pixels can be diminished. Thus, no matter the stereo display 300 is rotated 90 degrees along the clockwise or the counterclockwise direction, the 3D stereo image can still be generated effectively. Besides, the generated left-eye and right-eye pixel arrays when the stereo display 300 is rotated 180 and 270 degrees along the clockwise direction is the reversal of the pixel arrays when the display is not rotated or rotated 90 degrees, so the issue of identical color in adjacent sub-pixels can be solved. Accordingly, no matter how the stereo display 300 is rotated or what degrees it rotates, there are no issues of identical color in adjacent sub-pixels existing in respective pixel array of the left eye or the right eye, so that the correct image data of both eyes can be provided, thereby making the user able to watch the 3D stereo image in any direction.

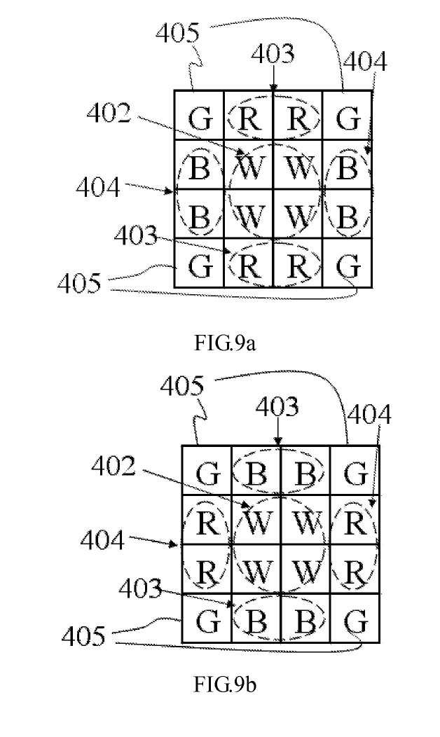

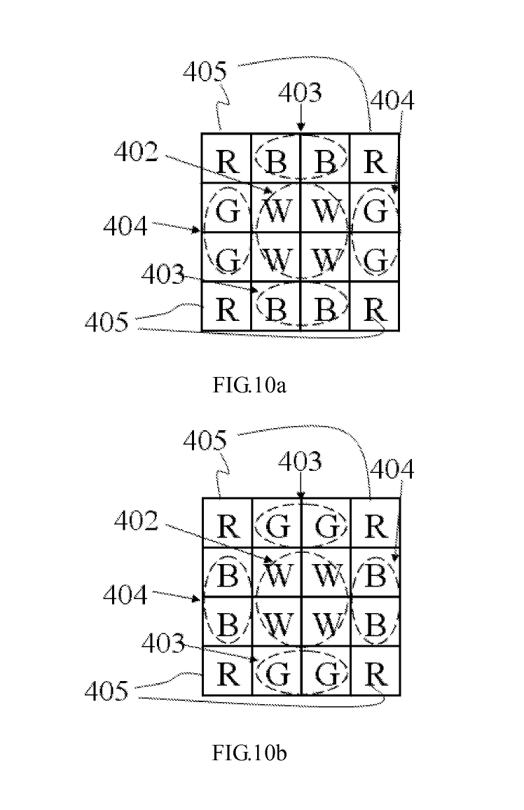

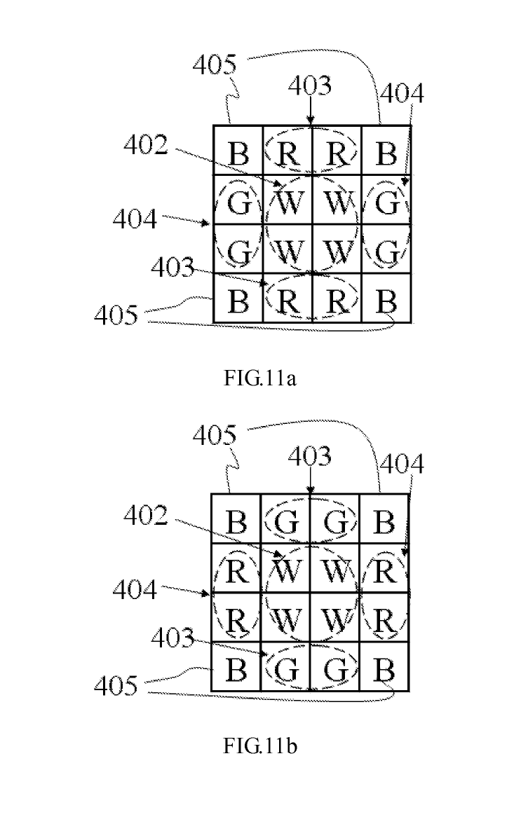

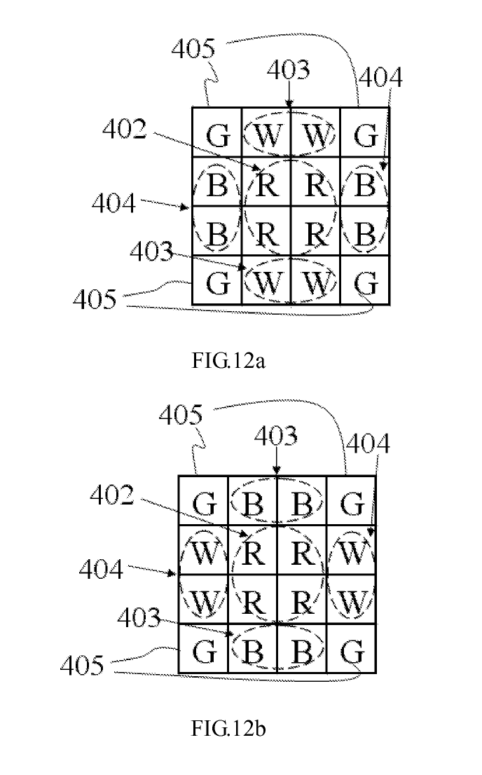

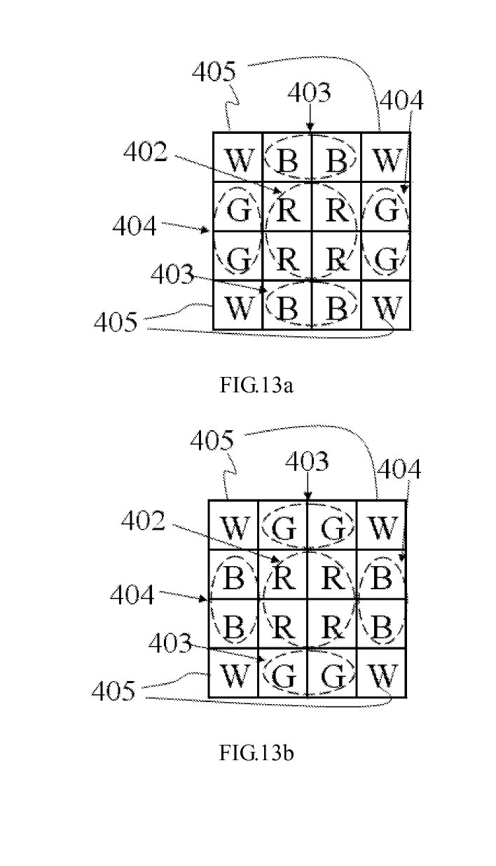

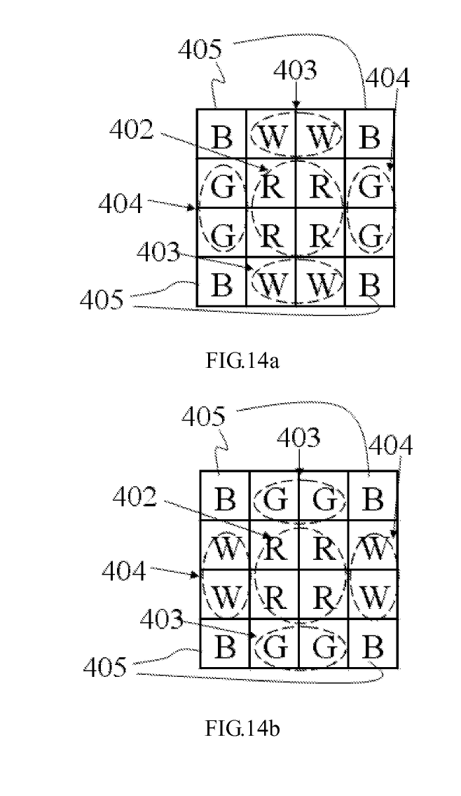

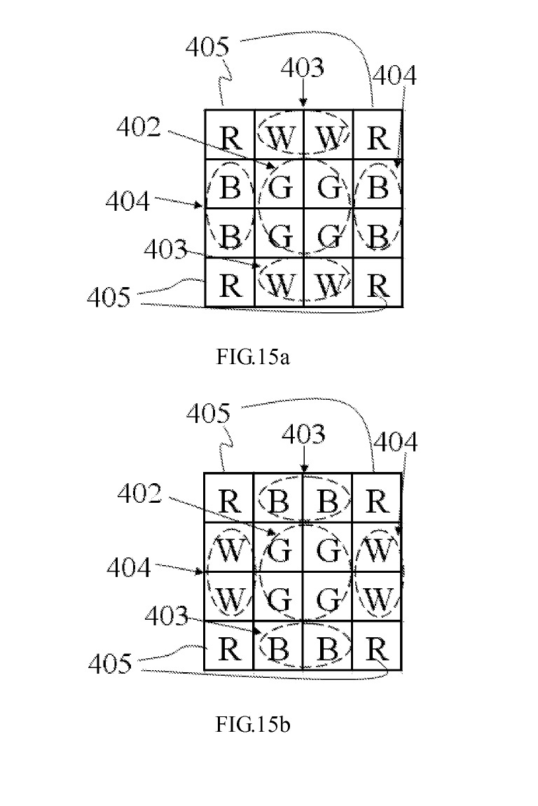

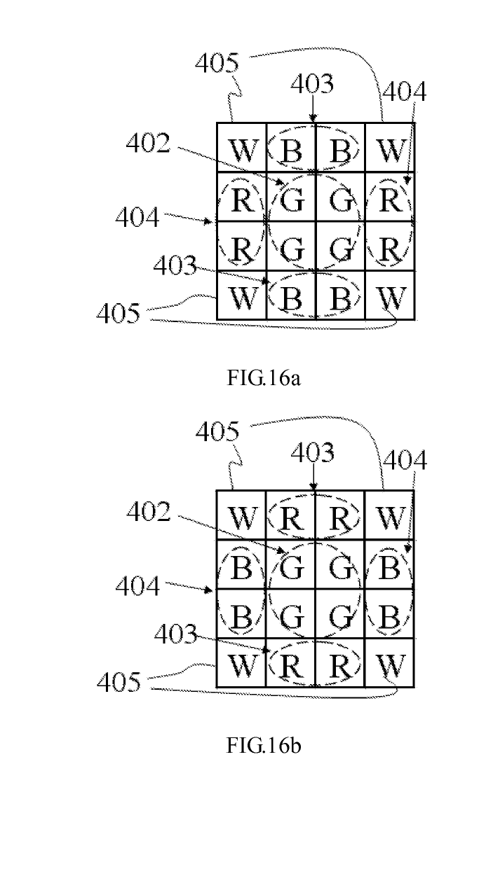

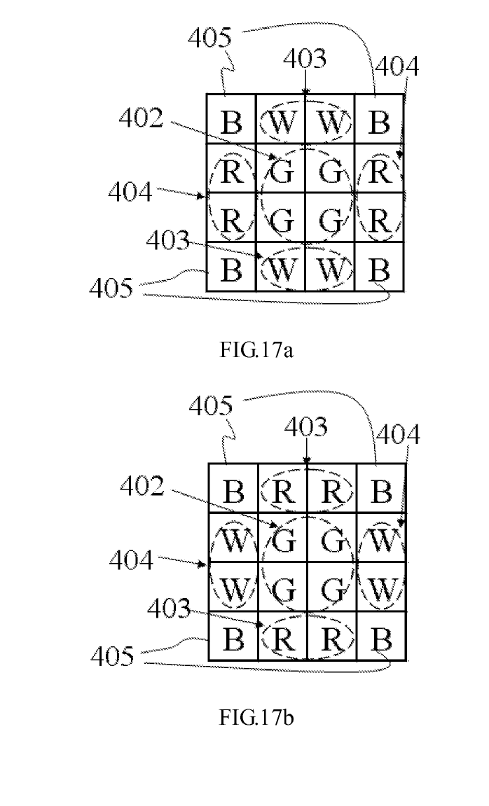

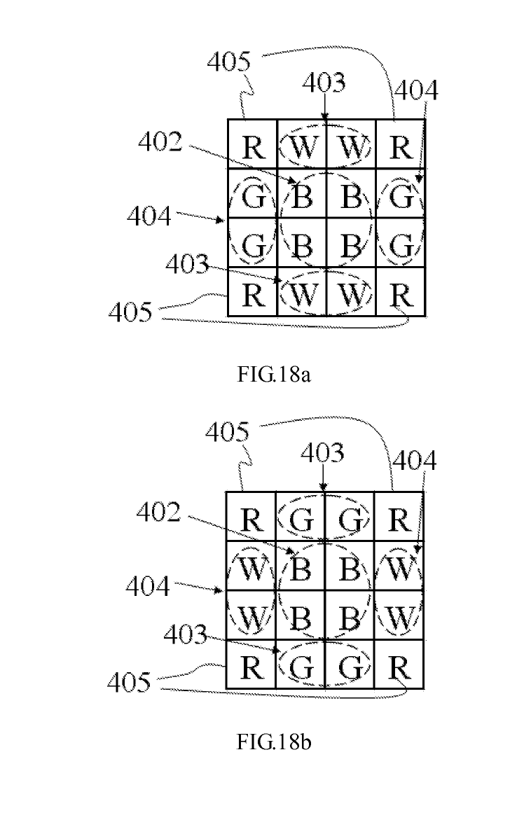

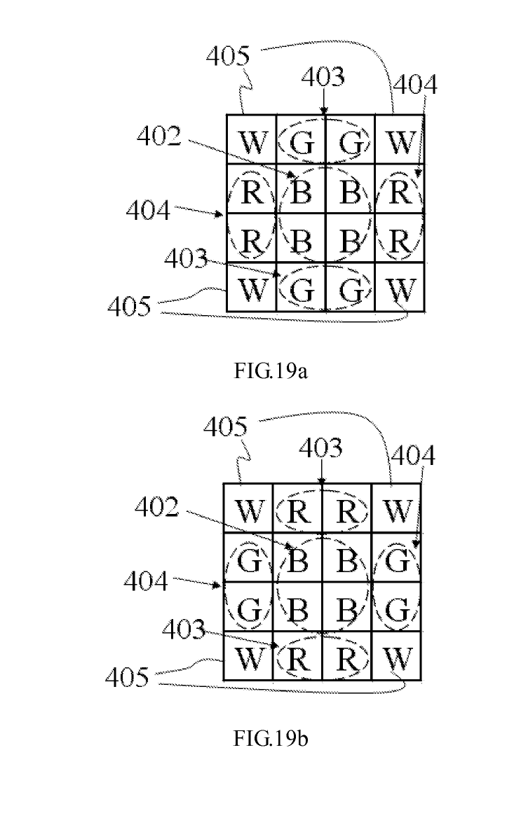

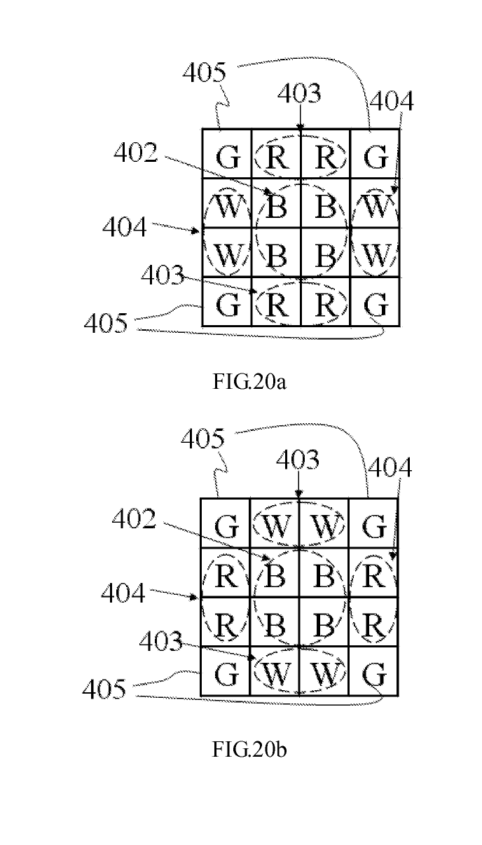

In some embodiments of the present invention, various arrangements of the sub-pixels can be introduced for providing different pixel unit matrices. 24 examples are described hereinafter, referred to FIG. 9a, 9b to FIG. 20a, 20b. However, these examples described hereinafter are just used for explaining, rather than limiting the present invention.

FIG. 9a depicts the preferred embodiment mentioned above, and FIG. 9b depicts the pixel unit matrix of which the pixel unit matrix of FIG. 9a is rotated 90 degrees along the clockwise direction, in other words, the second sub-pixels 403 are blue, and the third sub-pixels 404 are red. In FIG. 10a, the first sub-pixels 402 are white, and the second sub-pixels 403 are blue, and the third sub-pixels 404 are green, and the fourth sub-pixels 405 are red. FIG. 10b shows the result of the pixel unit matrix after rotating the pixel unit matrix of FIG. 10a by 90 degrees along the clockwise direction. To phrase another words, the second sub-pixels 403 are green, and the third sub-pixels 404 are blue. In FIG. 11a, the first sub-pixels 402 are white, and the second sub-pixels 403 are red, and the third sub-pixels 404 are green, and the fourth sub-pixels 405 are blue. In FIG. 11b, it shows the result after rotating the pixel unit matrix of FIG. 11a by 90 degrees along the clockwise direction. Namely, the second sub-pixels 403 are green, and the third sub-pixels 404 are red. In FIG. 12a, the first sub-pixels 402 are red, and the second sub-pixels 403 are white, and the third sub-pixels 404 are blue, and the fourth sub-pixels 405 are green. FIG. 12b shows the result after rotating the pixel unit matrix of FIG. 12a by 90 degrees along the clockwise direction. To phrase another words, the second sub-pixels 403 are blue, and the third sub-pixels 404 are white. In FIG. 13a, the first sub-pixels 402 are red, and the second sub-pixels 403 are blue, and the third sub-pixels 404 are green, and the fourth sub-pixels 405 are white. Similarly, FIG. 13b is the result after rotating FIG. 13a by 90 degrees along the clockwise direction. Namely, the second sub-pixels 403 are green, and the third sub-pixels 404 are blue. In FIG. 14a, the first sub-pixels 402 are red, and the second sub-pixels 403 are white, and the third sub-pixels 404 are green, and the fourth sub-pixels 405 are blue. After the pixel unit matrix of FIG. 14b is rotated 90 degrees along the clockwise direction, the pixel unit matrix is shown in FIG. 14b. Namely, the second sub-pixels 403 are green, and the third sub-pixels 404 are white. In FIG. 15a, the first sub-pixels 402 are green, and the second sub-pixels 403 are white, and the third sub-pixels 404 are blue, and the fourth sub-pixels 405 are red. The pixel unit matrix of FIG. 15b is the result after rotating the pixel unit matrix of FIG. 15a by 90 degrees along the clockwise direction. Namely, the second sub-pixels 403 are blue, and the third sub-pixels 404 are white. In FIG. 16a, the first sub-pixels 402 are green, and the second sub-pixels 403 are blue, and the third sub-pixels 404 are red, and the fourth sub-pixels 405 are white. The pixel unit matrix of FIG. 16b is the result after rotating the pixel unit matrix of FIG. 16a by 90 degrees along the clockwise direction. To phrase another words, the second sub-pixels 403 are red, and the third sub-pixels 404 are blue. In FIG. 17a, the first sub-pixels 402 are green, and the second sub-pixels 403 are white, and the third sub-pixels 404 are red, and the fourth sub-pixels 405 are blue. The pixel unit matrix of FIG. 17b is the result after rotating the pixel unit matrix of FIG. 17a by 90 degrees along the clockwise direction. To phrase another words, the second sub-pixels 403 are red, and the third sub-pixels 404 are white. In FIG. 18a, the first sub-pixels 402 are blue, and the second sub-pixels 403 are white, and the third sub-pixels 404 are green, and the fourth sub-pixels 405 are red. The pixel unit matrix of FIG. 18b is the result after rotating the pixel unit matrix of FIG. 18a by 90 degrees along the clockwise direction. To phrase another words, the second sub-pixels 403 are green, and the third sub-pixels 404 are white. In FIG. 19a, the first sub-pixels 402 are blue, and the second sub-pixels 403 are green, and the third sub-pixels 404 are red, and the fourth sub-pixels 405 are white. The pixel unit matrix of FIG. 19b is the result after rotating the pixel unit matrix of FIG. 19a by 90 degrees along the clockwise direction. To phrase another words, the second sub-pixels 403 are red, and the third sub-pixels 404 are green. In FIG. 20a, the first sub-pixels 402 are blue, and the second sub-pixels 403 are red, and the third sub-pixels 404 are white, and the fourth sub-pixels 405 are green. The pixel unit matrix of FIG. 20b is the result after rotating the pixel unit matrix of FIG. 20a by 90 degrees along the clockwise direction. To phrase another words, the second sub-pixels 403 are white, and the third sub-pixels 404 are red.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A stereo display comprising:
a pixel array having a plurality of pixel unit matrices;
a backlight module configured at one side by the pixel array, whereby emitting light to the pixel array; and
a barrier configured at another side by the pixel array;
wherein each of the plurality of pixel unit matrices comprising:
at least one first sub-pixel configured at a central area;
at least one second sub-pixel configured at an upper area and a lower area adjacent to the central area;
at least one third sub-pixel configured at a left and a right area adjacent to the central area; and
at least one fourth sub-pixel configured at matrix corner area, which is located at a corner of each of the plurality of pixel unit matrices.

2. The stereo display according to claim 1, wherein each of the plurality of pixel unit matrices is a n×n matrix, and n is a positive integer.

3. The stereo display according to claim 1, wherein the first sub-pixel, the second sub-pixel, the third sub-pixel, and the fourth sub-pixel have different colors.

4. The stereo display according to claim 1, wherein at least two of the first sub-pixel, the second sub-pixel, the third sub-pixel, and the fourth sub-pixel have identical color.

5. The stereo display according to claim 2, wherein n equals 4.

6. The stereo display according to claim 1, wherein the first sub-pixel, the second sub-pixel, the third sub-pixel, or the fourth sub-pixel includes white, red, green, or blue colors.

7. The stereo display according to claim 1, wherein the barrier is an oblique parallel latticed structure.

8. The stereo display according to claim 7, wherein a left-eye pixel array is formed when light is emitted from the stereo display at arbitrary angle to a left eye, and a right-eye pixel array is formed when light is emitted from the stereo display at an arbitrary angle to a right eye.

9. The stereo display according to claim 8, wherein the left-eye pixel array includes at least one left-eye pixel unit matrix, and the right-eye pixel array includes at least one right-eye pixel unit matrix.

10. The stereo display according to claim 9, wherein the left-eye pixel unit matrix and the right pixel unit matrix both comprise at least a red, a green, a blue sub-pixel, whereby forming a stereo image in an arbitrary angle.

11. The stereo display according to claim 10, wherein the left-eye pixel unit matrix and the right-eye pixel unit matrix further comprise at least one white sub-pixel, whereby improving luminosity.
